(19) United States
(12) Patent Application Publication
(10) Pub. No.: US 2025/0149810 A1
(43) Pub. Date: May 8, 2025

(54) PRESS-FIT TERMINAL

(71) Applicant: SUMITOMO WIRING SYSTEMS, LTD., Mie (JP)

(72) Inventor: Takuya YAMANAKA, Mie (JP)

(21) Appl. No.: 18/836,011

(22) PCT Filed: Jan. 26, 2023
(86) PCT No.: PCT/JP2023/002345

§ 371 Date: Aug. 6, 2024

(30) Foreign Application Priority Data
Feb. 10, 2022 (JP) 2022-019441

(51) Int. Cl. H01R 12/58

(52) U.S. Cl. CPC H01R 12/585

(57) ABSTRACT

A press-fit terminal includes a press-fit portion resiliently deformable in a direction orthogonal to an axial direction. The press-fit portion includes a first part located further away from an axial center than other parts of an outer periphery of a first cross-section on a part of the outer periphery of the first cross-section along the direction orthogonal to the axial direction. The press-fit portion includes a second part located further away from the axial center than other parts of an outer periphery of a second cross-section closer to a tip portion than the first cross-section on a part of the outer periphery of the second cross-section along the direction orthogonal to the axial direction. The first part and the second part are shifted and arranged at positions different in a circumferential direction when the press-fit portion is viewed from the axial direction.

### TECHNICAL FIELD

The present disclosure relates to a press-fit terminal.

### BACKGROUND

Patent Document 1 discloses a press-fit terminal provided with a press-fit portion (tip portion, introducing portion, press-fit holding portion and body portion) extending in an axial direction. The press-fit portion is resiliently deformable in a direction orthogonal to the axial direction and press-fit into a through-hole of a board. Press-fit terminals of this type are also disclosed in Patent Document 2 and 3.

### PRIOR ART DOCUMENT

### Patent Document

Patent Document 1: WO 2008/038331 A1
Patent Document 2: JP 2004-127610 A
Patent Document 3: JP 2016-201329 A

### SUMMARY OF THE INVENTION

### Problems to be Solved

The press-fit portion is required to contact the inner peripheral surface of the through-hole of the board with a predetermined contact load. Here, if the contact load is set to be high, an insertion force of the press-fit terminal to the board increases. Particularly, the insertion force of the press-fit terminal may increase beyond a permissible level under conditions that silver plating is applied to the through-hole and a lubricant is not applied to the press-fit portion. There is a problem that damage on the board increases if the insertion force of the press-fit terminal increases.

Accordingly, the present disclosure aims to provide a press-fit terminal capable of suppressing damage on a board while ensuring a contact load.

### Means to Solve the Problem

The present disclosure is directed to a press-fit terminal with a tapered tip portion located on a tip in an axial direction, and a press-fit portion located behind the tip portion in the axial direction, the press-fit portion being resiliently deformable in a direction orthogonal to the axial direction, the press-fit portion including a first part located further away from an axial center of the press-fit portion than other parts of an outer periphery of a first cross-section on a part of the outer periphery of the first cross-section along the direction orthogonal to the axial direction, and a second part located further away from the axial center of the press-fit portion than other parts of an outer periphery of a second cross-section closer to the tip portion than the first cross-section on a part of the outer periphery of the second cross-section along the direction orthogonal to the axial direction, and the first part and the second part being shifted and arranged at positions different in a circumferential direction when the press-fit portion is viewed from the axial direction.

### Effect of the Invention

According to the present disclosure, it is possible to provide a press-fit terminal capable of suppressing damage on a board while ensuring a contact load.

### BRIEF DESCRIPTION OF THE DRAWINGS

FIG. 1 is a bottom view of a press-fit terminal according to a first embodiment of the present disclosure.

FIG. 2 is a bottom view of a cut lower part of a press-fit portion inserted in a through-hole of a board.

FIG. 3 is a section along A-A of FIG. 2.

FIG. 4 is a section along B-B of FIG. 3.

FIG. 5 is a section along C-C of FIG. 3.

FIG. 6 is a graph showing a relationship of an insertion stroke of the press-fit terminal and an insertion force.

FIG. 7 is a front view of a press-fit terminal according to a second embodiment of the present disclosure.

FIG. 8 is a section along D-D of FIG. 7.

FIG. 9 is a section along E-E of FIG. 7.

FIG. 10 is a front view of a press-fit terminal according to a third embodiment of the present disclosure.

FIG. 11 is a section along F-F of FIG. 10.

FIG. 12 is a section along G-G of FIG. 10.

### DETAILED DESCRIPTION TO EXECUTE THE INVENTION

### Description of Embodiments of Present Disclosure

First, embodiments of the present disclosure are listed and described.

(1) The press-fit terminal of the present disclosure is provided with a tapered tip portion located on a tip in an axial direction, and a press-fit portion located behind the tip portion in the axial direction, the press-fit portion being resiliently deformable in a direction orthogonal to the axial direction, the press-fit portion including a first part located further away from an axial center of the press-fit portion than other parts of an outer periphery of a first cross-section on a part of the outer periphery of the first cross-section along the direction orthogonal to the axial direction, and a second part located further away from the axial center of the press-fit portion than other parts of an outer periphery of a second cross-section closer to the tip portion than the first cross-section on a part of the outer periphery of the second cross-section along the direction orthogonal to the axial direction, and the first part and the second part being shifted and arranged at positions different in a circumferential direction when the press-fit portion is viewed from the axial direction.

In the case of inserting the press-fit portion into a through-hole of a board, the second part contacts an inner peripheral surface (electrically conductive portion) of the through-hole and the other parts of the outer periphery of the second cross-section are not in contact with the inner peripheral surface of the through-hole or can contact the inner peripheral surface of the through-hole with a lower contact pressure than the second part in an insertion initial stage. In this stage, an insertion force of the press-fit terminal gradually increases due to an action such as adhesion caused by the contact of the second part and the board.

In an insertion final stage, the first part starts to contact the inner peripheral surface of the through-hole and the other parts of the outer periphery of the first cross-section are not in contact with the inner peripheral surface of the through-hole or can contact the inner peripheral surface of the through-hole with a lower contact pressure than the first part. An insertion force of the second part to the board is reduced and the other parts of the outer periphery of the first cross-section are arranged out of contact with or in low contact with the inner periphery of the through-hole. Here, the insertion force of the press-fit terminal can be temporarily lowered.

In a stage in which the press-fit portion is further inserted, the first part continues to contact the inner peripheral surface of the through-hole and the insertion force of the press-fit terminal increases due to an action such as adhesion caused by the contact of the first part and the board, but an insertion operation of the press-fit terminal can be finished before the insertion force reaches a permissible level.

Therefore, the press-fit terminal of this configuration can ensure a contact load to the board with damage on the board suppressed.

(2) Preferably, a plurality of the first parts are arranged at intervals in the circumferential direction on the outer periphery of the first cross-section, and a plurality of the second parts are arranged at intervals in the circumferential direction on the outer periphery of the second cross-section.

According to the above configuration, the respective first parts and the respective second parts can contact the inner peripheral surface of the through-hole of the board while being spaced apart in the circumferential direction, and a contact load can be distributed to the respective first parts and the respective second parts.

(3) The first parts may be formed on two first corner portions having a curved surface shape, out of a plurality of corner portions of the outer periphery of the first cross-section, and the second parts may be formed on two second corner portions having a curved surface shape, out of a plurality of corner portions of the outer periphery of the second cross-section.

According to the above configuration, the respective first corner portions and the respective second corner portions each having a curved surface shape can contact the inner peripheral surface of the through-hole of the board while being spaced apart in the circumferential direction, and a contact load can be stably ensured.

(4) The two first corner portions may be arranged at diagonal positions, out of four corner portions of the outer periphery of the first cross-section, and the two second corner portions may be arranged at diagonal positions, out of four corner portions of the outer periphery of the second cross-section.

According to the above configuration, the respective first corner portions and the respective second corner portions arranged at the diagonal positions can contact the inner peripheral surface of the through-hole of the board while being spaced apart in the circumferential direction, and the press-fit portion can be arranged in a well-balanced manner around the axial center in the through-hole of the board.

(5) The two first corner portions may have a smaller radius of curvature than the other two corner portions of the outer periphery of the first cross-section, and the two second corner portions may have a smaller radius of curvature than the other two corner portions of the outer periphery of the second cross-section.

According to the above configuration, the first part of each first corner portion and the second part of each second corner portion can be accurately formed by adjusting the radii of curvature at the time of manufacturing.

(6) An outer periphery of the press-fit portion may include a gradually changing portion for changing a shape in the axial direction between the first part and the second part in the axial direction.

According to the above configuration, a smooth transition can be made via the gradually changing portion from a stage in which the second part contacts the board to a stage in which the first part contacts the board.

### Details of Embodiments of Present Disclosure

Specific examples of the present disclosure are described below with reference to the drawings. Note that the present invention is not limited to this illustration, but is represented by claims and intended to include all changes in the scope of claims and in the meaning and scope of equivalents.

### First Embodiment

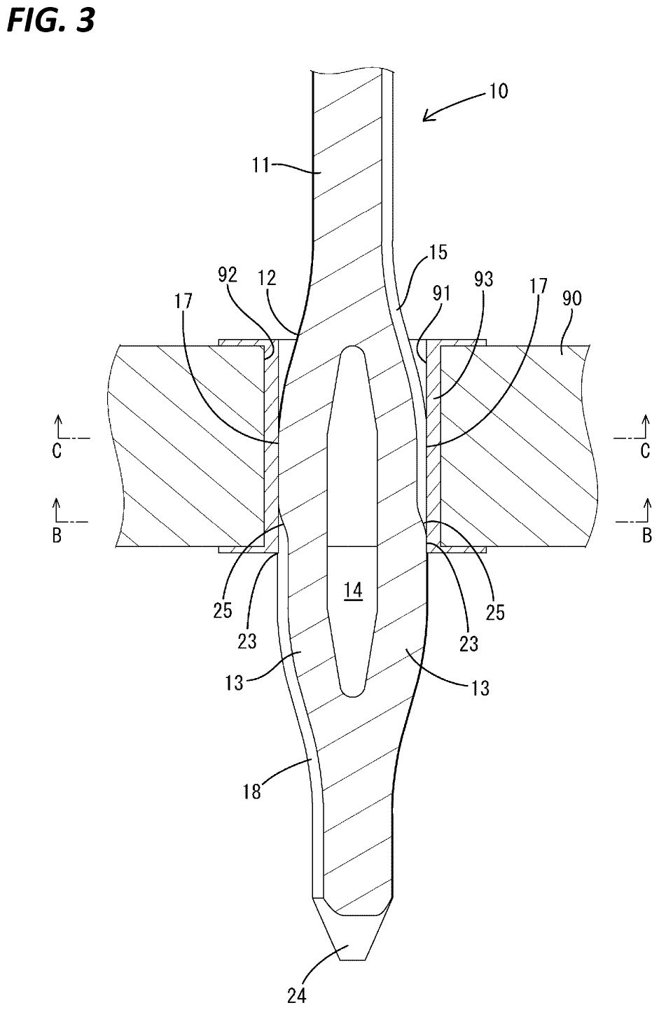

A press-fit terminal 10 according to a first embodiment constitutes a part of a connector to be installed in a vehicle although not shown. The connector is provided with a housing made of synthetic resin for mounting the press-fit terminal 10. The press-fit terminal 10 is inserted into a through-hole 91 of a board 90 such as a printed circuit board as the connector is mounted on the board 90. As shown in FIG. 3, the inner peripheral surface of the through-hole 91 is constituted by an electrically conductive portion 93 made of an electrically conductive material such as copper plating covering the inner peripheral surface of a hole 92 of the board 90.

The press-fit terminal 10 is formed, such as by press-working an electrically conductive metal plate. The press-fit terminal 10 is provided with a board connecting portion 11 in the form of an elongated tab and extending in an axial direction (vertical direction of FIG. 3).

The board connecting portion 11 includes a tip portion 24 tapered toward a lower end. The press-fit terminal 10 is inserted into the through-hole 91 of the board 90 with the tip portion 24 in the lead. The board connecting portion 11 includes a press-fit portion 12 above (rear side in an insertion direction into the through-hole 91, rear side in the axial direction) the tip portion 24. The press-fit portion 12 of the first embodiment has a so-called needle eye shape and includes a pair of beam portions 13 bulging laterally and a vertically long slit 14 penetrating through an axial center C between the respective beam portions 13.

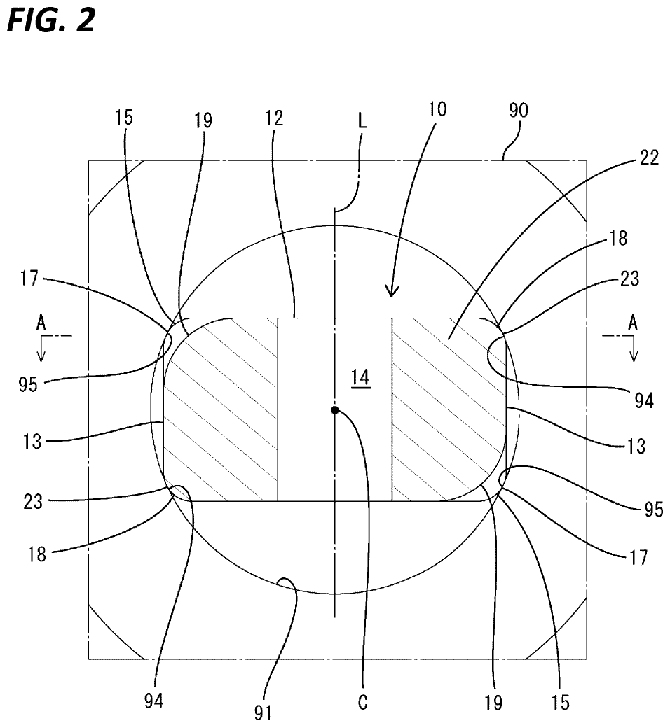

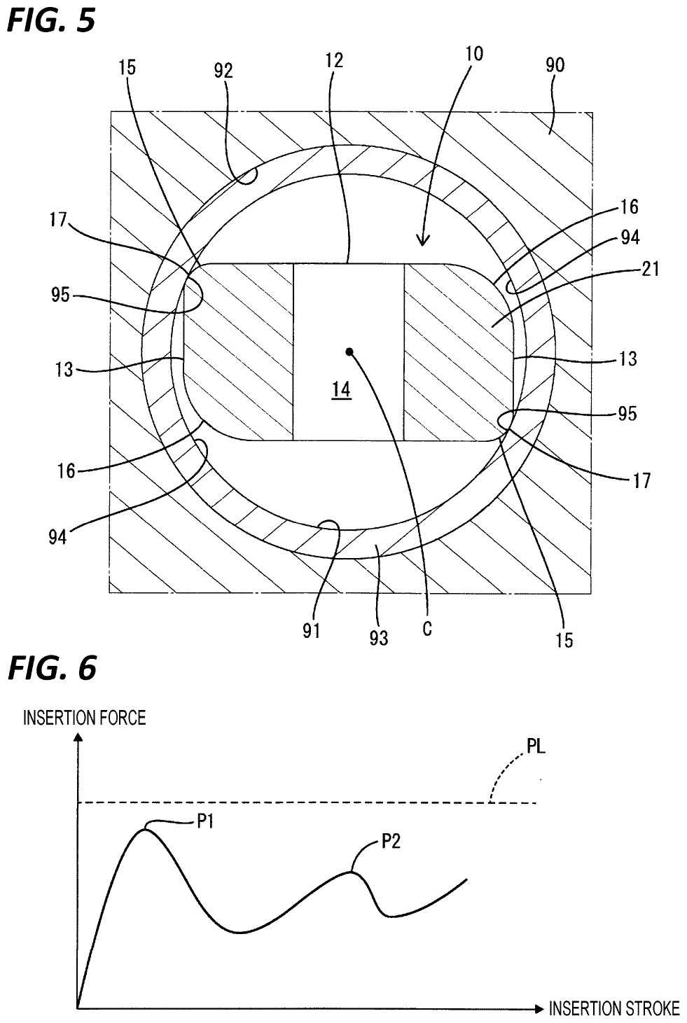

A cross-section (transverse section) of the press-fit portion 12 cut in a direction orthogonal to the axial direction has a shape point symmetrical about the axial center C and laterally asymmetrical with respect to a plane of symmetry L passing through the axial center C along a front-rear direction as shown in FIG. 2. Note that FIG. 2 shows a cross-section obtained by cutting a lower part of the press-fit portion 12 in the direction orthogonal to the axial direction and, hereinafter, this cross-section is referred to as a second cross-section 22. FIG. 5 shows a cross-section obtained by cutting an upper part of the press-fit portion 12 in the direction orthogonal to the axial direction and, hereinafter, this cross-section is referred to as a first cross-section 21. The second cross-section 22 is arranged closer to the tip portion 24 than the first cross-section 21.

As shown in FIG. 5, the press-fit portion 12 includes four corner portions 15, 16 on the outer periphery of the first cross-section 21. In the case of the first embodiment, the respective corner portions 15, 16 are formed on outer peripheral corner portions on sides of the respective beam portions 13 opposite to the slit 14. Each corner portion 15, 16 has a curved surface shape, in particular an arcuate shape.

Out of the respective corner portions 15, 16, two corner portions (hereinafter, referred to as first corner portions 15) are formed to have a smaller radius of curvature than the other two corner portions (hereinafter, referred to as third corner portions 16). The respective first corner portions 15 are arranged at diagonal positions on the outer periphery of the first cross-section 21. The respective second corner portions 16 are arranged at other diagonal positions on the outer periphery of the first cross-section 21.

Each first corner portion 15 includes a first part 17 on a top. The first part 17 of each first corner portion 15 is arranged at a position more distant from the axial center C than a top of each third corner portion 16. The first parts 17 of the respective first corner portions 15 are equidistant from the axial center C and arranged at positions most distant from the axial center C, out of the respective corner portions 15, 16. As shown in FIG. 3, the first corner portion 15 is formed to extend in the axial direction from a vertical center side of the press-fit portion 12 to a position above the press-fit portion 12 in the axial direction.

As shown in FIG. 2, the press-fit portion 12 includes four corner portions 18, 19 on the outer periphery of the second cross-section 22, similarly to the first cross-section 21. Two corner portions (hereinafter, referred to as second corner portions 18) at diagonal positions on the outer periphery of the second cross-section 22 are formed to have a smaller radius of curvature than the other two corner portions (hereinafter, referred to as fourth corner portions 19). Each second corner portion 18 includes a second part 23 on a top most distant from the axial center C on the outer periphery of the second cross-section 22. As shown in FIG. 3, the second corner portion 18 is formed to extend in the axial direction from the vertical center side of the press-fit portion 12 to the tip portion 24 in the axial direction.

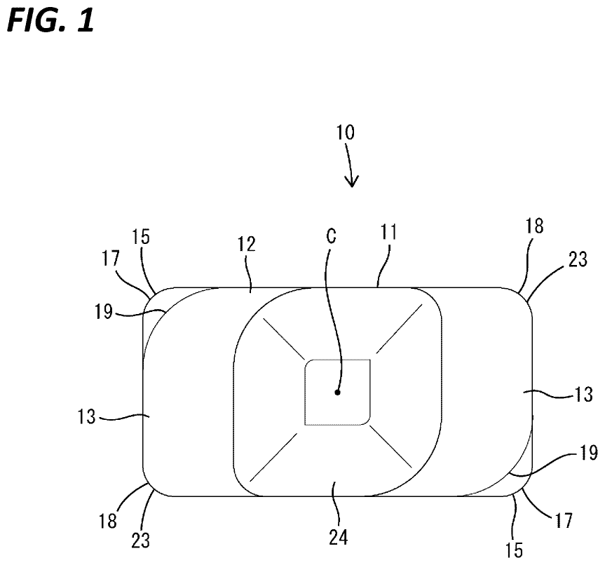

The respective fourth corner portions 19 are arranged below the respective first corner portions 15 (see FIGS. 1 and 2). The respective second corner portions 18 are arranged below the respective third corner portions 16. As shown in FIG. 1, when the press-fit terminal 10 is viewed from the axial direction, the second parts 23 of the respective second corner portions 18 and the first parts 17 of the respective first corner portions 15 are shifted and arranged at positions different in the circumferential direction so as not to overlap each other.

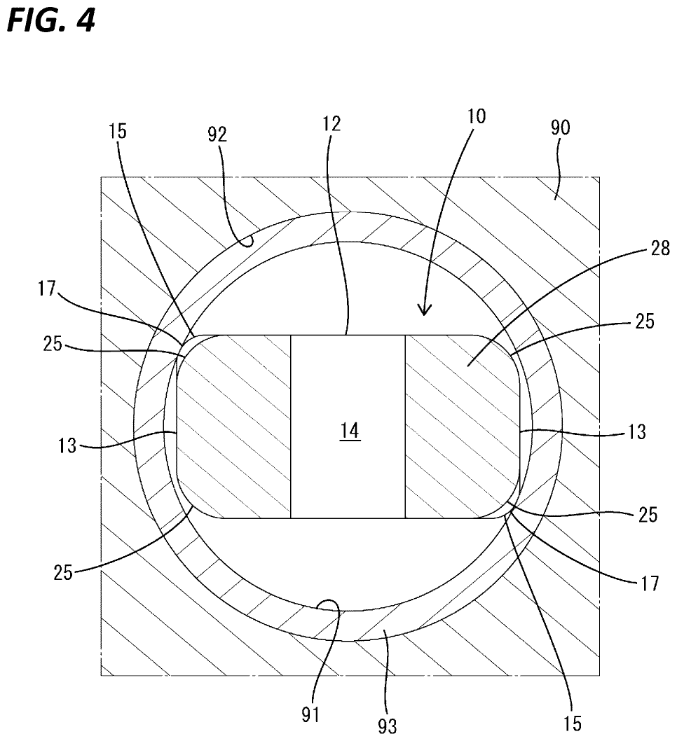

As shown in FIG. 3, the outer periphery of the press-fit portion 12 includes gradually changing portions 25 for gradually changing a shape in the axial direction in vertical intermediate parts between the first corner portions 15 and the second corner portions 18. The gradually changing portions 25 have a curved surface shape continuously connecting the outer peripheral shape of the first cross-section 21 and that of the second cross-section 22. In the case of the first embodiment, the gradually changing portions 25 connect the first parts 17 and the fourth corner portions 19 obliquely to the axial direction, and connect the second parts 23 and the third corner portions 16 obliquely to the axial direction. The gradually changing portions 25 are formed on four corner portions on the outer periphery of a cross-section (hereinafter, referred to as a third cross-section 28) obtained by cutting the vertical intermediate part of the press-fit portion 12 in the direction orthogonal to the axial direction. The four corner portions constituting the gradually changing portions 25 change radii of curvature in the axial direction and can have the same radius of curvature in the third cross-section 28 in the vertical intermediate part as shown in FIG. 4.

Next, functions of the press-fit terminal 10 are described.

The press-fit terminal 10 is inserted into the through-hole 91 of the board 90 from above with the tip portion 24 facing downward. In an insertion initial stage of inserting the press-fit portion 12 into the through-hole 91 of the board 90, the outer peripheral corner portions of the respective beam portions 13 contact the inner peripheral surface of the through-hole 91 and are largely deformed radially inward. In this way, as shown in FIG. 6, an insertion force increases and shows a first insertion force peak P1. Thereafter, the respective beam portions 13 are deformed along the inner peripheral surface of the through-hole 91 and the insertion force is gradually reduced as the shape changes of the respective beam portions 13 become smaller.

Further, in the insertion initial stage, the second parts 23 of the respective second corner portions 18 contact both radial end parts on the inner peripheral surface of the through-hole 91 (parts continuously extending in the axial direction from the parts in contact with the respective second parts 23 on the inner peripheral surface of the through-hole 91; hereinafter, referred to as preceding sliding parts 94). The respective fourth corner portions 19 are facing parts shifted in the circumferential direction from the preceding sliding parts 94 on the inner peripheral surface of the through-hole 91 (parts continuously extending in the axial direction from the parts facing the respective fourth corner portions 19 on the inner peripheral surface of the through-hole 91; hereinafter, referred to as succeeding sliding parts 95), but are lightly in contact with the succeeding sliding parts 95 or not in contact with the inner peripheral surface of the through-hole 91 as shown in FIG. 2. Due to an action such as adhesion caused by the contact of the second parts 23 of the respective second corner portions 18 and the preceding sliding parts 94, the insertion force increases again and shows a second insertion force peak P2 as shown in FIG. 6. Note that, although the insertion force peak P2 is smaller than the insertion force peak P1 in FIG. 6, the insertion force peak P2 may be larger than the insertion force peak P1 depending on various conditions such as the shape of the press-fit terminal 10. In the first embodiment, the insertion force is prevented from directly increasing from the insertion force peak P2 and reaching an permissible level PL as described later.

If the press-fit terminal 10 is further inserted and an insertion final stage is reached, the second parts 23 of the respective second corner portions 18 no longer strongly contact the preceding sliding parts 94 and the insertion force is gradually reduced. Here, the gradually changing portions 25 enter the through-hole 91, but are lightly in contact with the inner peripheral surface of the through-hole 91 or not in contact with the inner peripheral surface of the through-hole 91 as shown in FIG. 4.

Thereafter, as shown in FIG. 5, a transition is made to a stage in which the respective first corner portions 15 and the respective third corner portions 16 enter the through-hole 91. The respective third corner portions 16 are facing the preceding sliding parts 94, but are lightly in contact with the preceding sliding parts 94 or not in contact with the inner peripheral surface of the through-hole 91 as shown in FIG. 5. The first parts 17 of the respective first corner portions 15 are in contact with the succeeding sliding parts 95, but are not strongly in contact with the succeeding sliding parts 95 since the respective beam portions 13 are deformed radially inward. Further, the succeeding sliding parts 95 not in contact with the second parts 23 are not largely abraded. Therefore, the insertion force does not increase in the initial stage in which the first parts 17 of the respective first corner portions 15 contact the succeeding sliding parts 95.

As the press-fit terminal 10 is further inserted, the insertion force gradually increases as shown in FIG. 6 due to an action such as adhesion caused by the contact of the first parts 17 of the respective first corner portions 15 and the succeeding sliding parts 95. However, a period during which the first parts 17 of the respective first corner portions 15 contact the succeeding sliding parts 95 is short and an insertion operation of the press-fit terminal 10 is completed before the insertion force reaches the permissible level PL. With the insertion of the press-fit terminal 10 completed, the second parts 23 of the second corner portions 18 are in contact with the inner peripheral surface of the through-hole 91 on the underside of the board 90 and the first parts 17 of the first corner portions 15 are in contact with the inner peripheral surface of the through-hole 91 on the front surface side of the board 90 as shown in FIG. 3. In this way, the press-fit terminal 10 can ensure a contact load to the board 90.

In the case of the first embodiment, the preceding sliding parts 94 to be contacted by the second parts 23 of the respective second corner portions 18 and the succeeding sliding parts 95 to be contacted by the first parts 17 of the respective first corner portions 15 are shifted and arranged at the positions different in the circumferential direction when viewed from the axial direction. Thus, large damage is not given to the board 90 with the press-fit terminal 10 connected to the board 90.

Further, in the case of the first embodiment, the second parts 23 of the respective second corner portions 18 are arranged in pair on the outer periphery of the second cross-section 22 while being spaced apart in the circumferential direction, and the first parts 17 of the respective first corner portions 15 are arranged in pair on the outer periphery of the first cross-section 21 while being spaced apart in the circumferential direction. Thus, the contact load to the board 90 is distributed to the second parts 23 of the respective second corner portions 18 and the first parts 17 of the respective first corner portions 15 and the damage of the board 90 can be more reduced.

Further, since the second parts 23 of the respective second corner portions 18 are arranged at the diagonal positions on the outer periphery of the second cross-section 22, and the first parts 17 of the respective first corner portions 15 are arranged at the diagonal positions on the outer periphery of the first cross-section 21, the press-fit portion 12 is arranged in a well-balanced manner around the axial center C in the through-hole 91 of the board 90.

Further, each second corner portion 18 has a smaller radius of curvature than each fourth corner portion 19 and the second part 23 of each second corner portion 18 can be accurately formed by adjusting the radius of curvature. Similarly, each first corner portion 15 has a smaller radius of curvature than each third corner portion 16 and the first part 17 of each first corner portion 15 can be accurately formed by adjusting the radius of curvature. Further, each first corner portion 15 and each second corner portion 18 are both formed to extend in the axial direction in the press-fit portion 12 and the processability of the press-fit terminal 10 is excellent.

Further, since the gradually changing portions 25 are formed between the first parts 17 and the second parts 23 and a smooth transition can be made via the gradually changing portions 25 from a stage in which the second parts 23 contact the board 90 to a stage in which the first parts 17 contact the board 90, insertion operability into the through-hole 91 of the board 91 is excellent.

### Second Embodiment

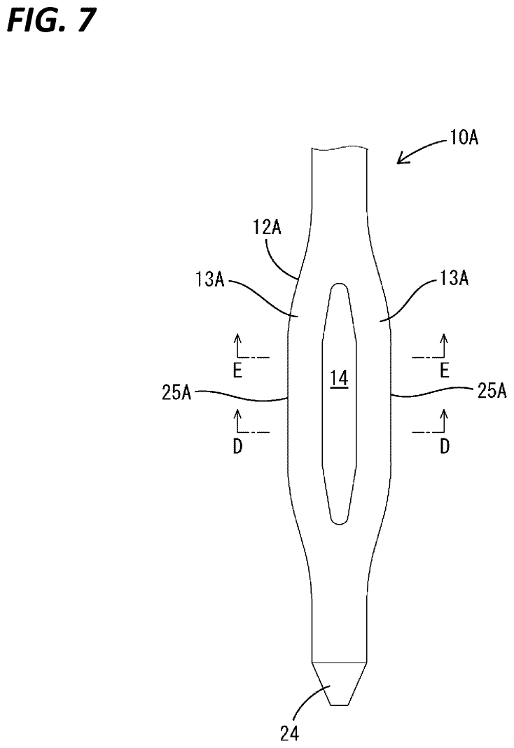

A press-fit terminal 10A according to a second embodiment of the present disclosure is shown in FIGS. 7 to 9. The press-fit terminal 10A is provided with a press-fit portion 12A having a shape different from that of the first embodiment. The other configuration is as in the first embodiment and repeated description is omitted.

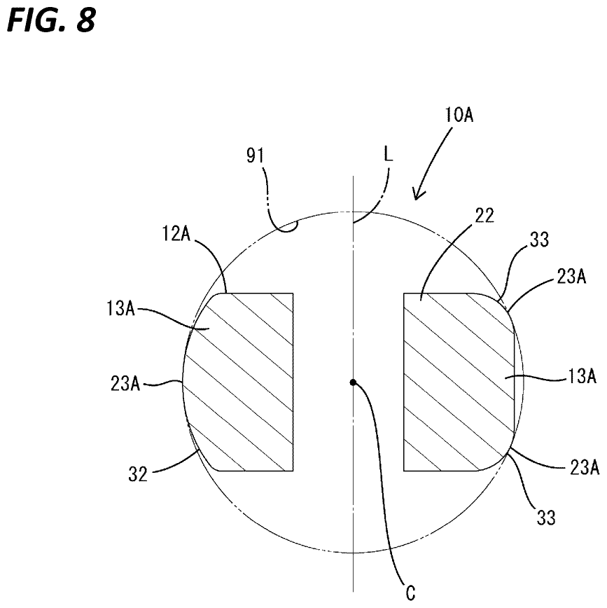

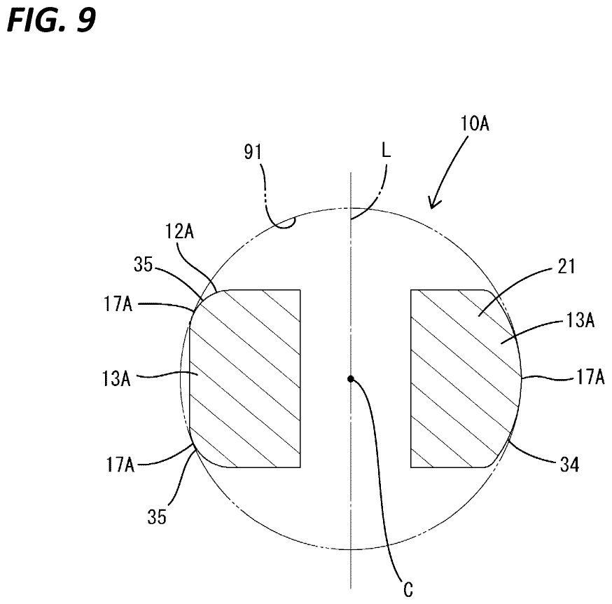

In the press-fit portion 12A, left and right beam portions 13A have different shapes. As shown in FIG. 9, a first cross-section 21 of the press-fit portion 12A (transverse section of an upper part of the press-fit portion 12A) shows a shape laterally asymmetrical with respect to a plane of symmetry L along a front-rear direction passing through an axial center C and point-asymmetrical. Similarly, as shown in FIG. 8, a second cross-section 22 of the press-fit portion 12A (transverse section of a lower part of the press-fit portion 12A) shows a shape laterally asymmetrical with respect to the plane of symmetry L along the front-rear direction passing through the axial center C and point-asymmetrical.

The right beam portion 13A of FIG. 9 in the first cross-section 21 includes a first curved surface portion 34 entirely having an arcuate shape on an outer periphery. A top of the right end of the first curved surface portion 34 is formed as a first part 17A most distant from the axial center C on the outer periphery of the first cross-section 21.

The right beam portion 13A of FIG. 9 in the first cross-section 21 includes a pair of front and rear sixth corner portions 35 protruding to have a curved surface shape. The respective sixth corner portions 35 have the same radius of curvature. A top of each sixth corner portion 35 is formed as a first part 17A most distant from the axial center C on the outer periphery of the first cross-section 21.

The left beam portion 13A of FIG. 8 in the second cross-section 22 includes a second curved surface portion 32 entirely having an arcuate shape on an outer periphery. A top of the left end of the second curved surface portion 32 is formed as a second part 23A most distant from the axial center C on the outer periphery of the second cross-section 22.

The right beam portion 13A of FIG. 8 in the second cross-section 22 includes a pair of front and rear fifth corner portions 33 protruding to have a curved surface shape. The respective fifth corner portions 33 have the same radius of curvature. A top of each fifth corner portion 33 is formed as a second part 23A most distant from the axial center C on the outer periphery of the second cross-section 22.

When the press-fit terminal 10A is viewed from an axial direction, the respective second parts 23A and the respective first parts 17A are shifted and arranged at positions different in the circumferential direction so as not to overlap each other.

Although not shown in detail, the outer periphery of the press-fit portion 12A includes gradually changing portions 25A (see FIGS. 7) continuously connecting the outer peripheral shape of the first cross-section 21 and that of the second cross-section 22 between the first parts 17A and the second parts 23A.

In an insertion initial stage of inserting the press-fit terminal 10A into a board 90, the second parts 23A of the respective fifth corner portions 33 and the second part 23A of the second curved surface portion 32 respectively contact the inner peripheral surface of the through-hole 91 at three positions spaced apart in a circumferential direction as shown in FIG. 8.

In an insertion final stage, the first parts 17A of the respective sixth corner portions 35 and the first part 17A of the first curved surface portion 34 respectively contact the inner peripheral surface of the through-hole 91 at three positions spaced apart in the circumferential direction as shown in FIG. 9.

On the inner peripheral surface of the through-hole 91, the three positions in contact with the respective second parts 23A and the three positions in contact with the respective first parts 17A are shifted and arranged at positions different in the circumferential direction when viewed from the axial direction. Therefore, in the second embodiment, a contact load of the press-fit terminal 10A to the board 90 can be ensured and the damage of the board 90 can be suppressed as in the first embodiment.

### Third Embodiment

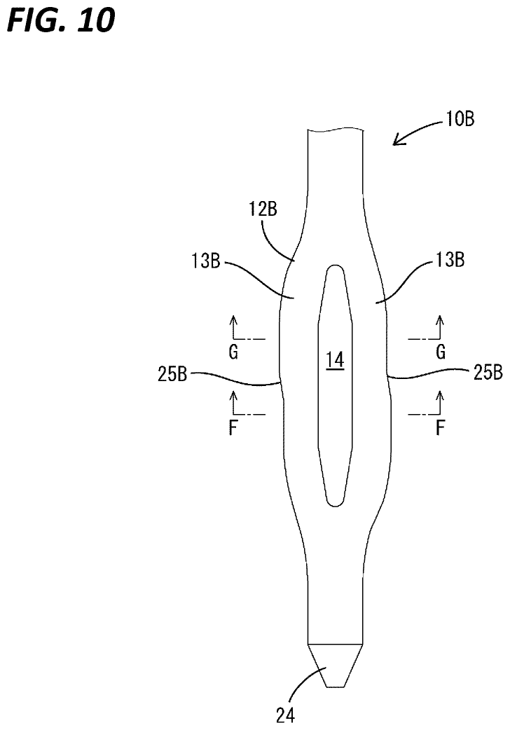

A press-fit terminal 10B according to a third embodiment of the present disclosure is shown in FIGS. 10 to 12. The press-fit terminal 10B is provided with a press-fit portion 12B having a shape different from those of the first and second embodiments. The other configuration is as in the first and second embodiments and repeated description is omitted.

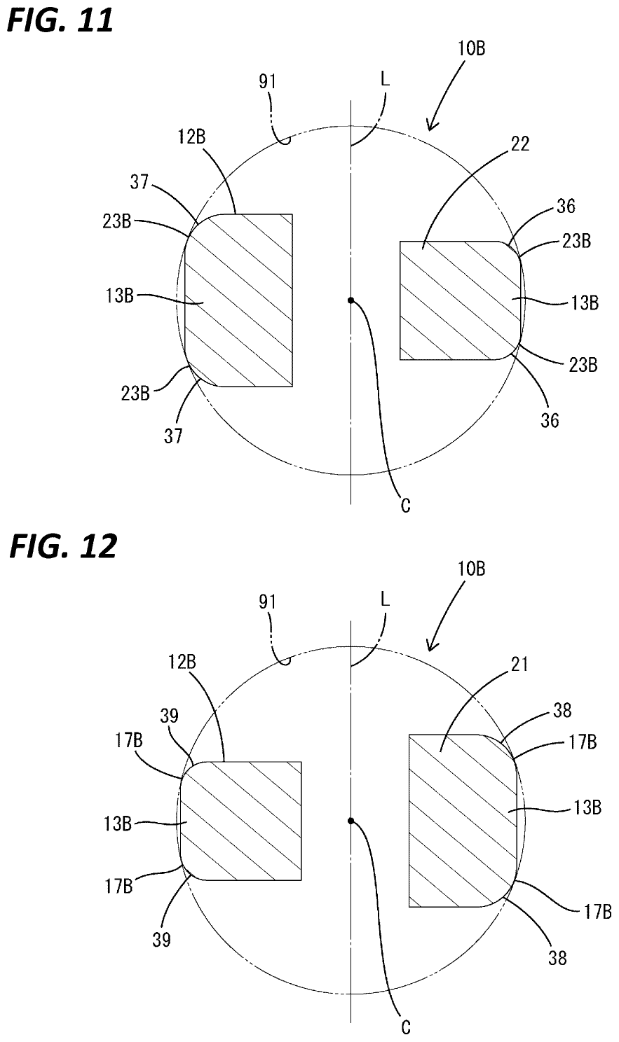

In the press-fit portion 12B, left and right beam portions 13B have different shapes. As shown in FIG. 12, a first cross-section 21 of the press-fit portion 12B (transverse section of an upper part of the press-fit portion 12B) shows a shape laterally asymmetrical with respect to a plane of symmetry L along a front-rear direction passing through an axial center C and point-asymmetrical. Similarly, as shown in FIG. 11, a second cross-section 22 of the press-fit portion 12B (transverse section of a lower part of the press-fit portion 12B) shows a shape laterally asymmetrical with respect to the plane of symmetry L along the front-rear direction passing through the axial center C and point-asymmetrical.

The right beam portion 13B of FIG. 12 in the first cross-section 21 has a larger dimension in the front-rear direction (dimension in a vertical direction of FIG. 12) than the left beam portion 13B and includes a pair of front and rear ninth corner portions 38 protruding to have a curved surface shape on an outer periphery. A top of each ninth corner portion 38 is formed as a first part 17B most distant from the axial center C in the first cross-section 21.

The left beam portion 13B of FIG. 12 in the first cross-section 21 has a larger lateral dimension than the left beam portion 13B and includes a pair of front and rear tenth corner portions 39 protruding to have a curved surface shape on an outer periphery. A top of each tenth corner portion 39 is formed as a first part 17B most distant from the axial center C in the first cross-section 21. The ninth and tenth corner portions 38, 39 have the same radius of curvature.

The right beam portion 13B of FIG. 11 has a larger lateral dimension than the left beam portion 13B and includes a pair of front and rear seventh corner portions 36 protruding to have a curved surface shape on an outer periphery. A top of each seventh corner portion 36 is formed as a second part 23B most distant from the axial center C in the first cross-section 21.

The left beam portion 13B of FIG. 11 in the second cross-section 22 has a larger dimension in the front-rear direction (dimension in the vertical direction of FIG. 11) than the right beam portion 13B and includes a pair of front and rear eighth corner portions 37 protruding to have a curved surface shape on an outer periphery. A top of each eighth corner portion 37 is formed as a second part 23B most distant from the axial center C in the second cross-section 22. The seventh and eighth corner portions 36, 37 have the same radius of curvature.

When the press-fit terminal 10B is viewed from the axial direction, the respective second parts 23B and the respective first parts 17B are shifted and arranged at positions different in the circumferential direction so as not to overlap each other.

Although not shown in detail, the outer periphery of the press-fit portion 12B includes gradually changing portions 25B (see FIGS. 10) continuously connecting the outer peripheral shape of the first cross-section 21 and that of the second cross-section 22 between the first parts 17B and the second parts 23B.

In an insertion initial stage of inserting the press-fit terminal 10B into a board 90, the second parts 23B of the respective seventh corner portions 36 and the second part 23B of the eighth curved surface portion 37 respectively contact the inner peripheral surface of the through-hole 91 at four positions spaced apart in a circumferential direction.

In an insertion final stage, the first parts 17B of the respective ninth corner portions 38 and the first parts 17B of the respective tenth corner portions 39 respectively contact the inner peripheral surface of the through-hole 91 at four positions spaced apart in the circumferential direction.

On the inner peripheral surface of the through-hole 91, the four positions in contact with the respective second parts 23B and the four positions in contact with the respective first parts 17B are shifted and arranged at positions different in the circumferential direction when viewed from the axial direction. Therefore, in the third embodiment, a contact load of the press-fit terminal 10B to the board 90 can be ensured and the damage of the board 90 can be suppressed as in the first and second embodiments.

### Other Embodiments of Present Disclosure

The first to third embodiments disclosed this time should be considered illustrative in all aspects, rather than restrictive.

In the case of the above first to third embodiments, the press-fit terminal is provided with the press-fit portion having a needle eye shape and including the pair of beam portions on both left and right sides of the slit. However, as another embodiment, the press-fit terminal may be provided with a press-fit portion resiliently deformable in the direction orthogonal to the axial direction and the press-fit portion is not limited to the needle eye-shaped press-fit portion, but may have a C-shaped, M-shaped, N-shaped and Z-shaped cross-sectional shapes.

In the case of the above first to third embodiments, the first and second parts are formed to extend in the axial direction in the press-fit portion. However, as another embodiment, the first and second parts may be formed to extend in a direction intersecting the axial direction on the outer periphery of the press-fit portion. For example, the first and second parts may be formed to helically extend on the outer periphery of the press-fit portion.

In the case of the above first to third embodiments, the second parts are in contact with the inner peripheral surface of the through-hole with the press-fit portion properly inserted in the through-hole of the board. However, as another embodiment, the second parts may come out from the through-hole of the board and be arranged on the underside of the board with the press-fit portion properly inserted in the through-hole of the board.

### LIST OF REFERENCE NUMERALS

10, 10A, 10B . . . press-fit terminal
11 . . . board connecting portion
12, 12A, 12B . . . press-fit portion
13, 13A, 13B . . . beam portion
14 . . . slit
15 . . . first corner portion
16 . . . third corner portion
17, 17A, 17B . . . first part
18 . . . second corner portion
19 . . . fourth corner portion
21 . . . first cross-section
22 . . . second cross-section
23, 23A, 23B . . . second part
24 . . . tip portion
25, 25A, 25B . . . gradually changing portion
28 . . . third cross-section
32 . . . second curved surface portion
33 . . . fifth corner portion
34 . . . first curved surface portion
35 . . . sixth corner portion
36 . . . seventh corner portion
37 . . . eighth corner portion
38 . . . ninth corner portion
39 . . . tenth corner portion
90 . . . board
91 . . . through-hole
92 . . . hole
93 . . . electrically conductive portion
94 . . . preceding sliding part
95 . . . succeeding sliding part
C . . . axial center
L . . . plane of symmetry
PL . . . permissible level
P1, P2 . . . insertion force peak

1. A press-fit terminal, comprising:
a tapered tip portion located on a tip in an axial direction; and
a press-fit portion located behind the tip portion in the axial direction, the press-fit portion being resiliently deformable in a direction orthogonal to the axial direction,
the press-fit portion including:
a first part located further away from an axial center of the press-fit portion than other parts of an outer periphery of a first cross-section on a part of the outer periphery of the first cross-section along the direction orthogonal to the axial direction; and
a second part located further away from the axial center of the press-fit portion than other parts of an outer periphery of a second cross-section closer to the tip portion than the first cross-section on a part of the outer periphery of the second cross-section along the direction orthogonal to the axial direction, and
the first part and the second part being shifted and arranged at positions different in a circumferential direction when the press-fit portion is viewed from the axial direction.

2. The press-fit terminal of claim 1, wherein:
a plurality of the first parts are arranged at intervals in the circumferential direction on the outer periphery of the first cross-section, and
a plurality of the second parts are arranged at intervals in the circumferential direction on the outer periphery of the second cross-section.

3. The press-fit terminal of claim 2, wherein:
the first parts are formed on two first corner portions having a curved surface shape, out of a plurality of corner portions of the outer periphery of the first cross-section, and
the second parts are formed on two second corner portions having a curved surface shape, out of a plurality of corner portions of the outer periphery of the second cross-section.

4. The press-fit terminal of claim 3, wherein:
the two first corner portions are arranged at diagonal positions, out of four corner portions of the outer periphery of the first cross-section, and
the two second corner portions are arranged at diagonal positions, out of four corner portions of the outer periphery of the second cross-section.

5. The press-fit terminal of claim 4, wherein:
the two first corner portions have a smaller radius of curvature than the other two corner portions of the outer periphery of the first cross-section, and
the two second corner portions have a smaller radius of curvature than the other two corner portions of the outer periphery of the second cross-section.

6. The press-fit terminal of claim 1, wherein an outer periphery of the press-fit portion includes a gradually changing portion for changing a shape in the axial direction between the first part and the second part in the axial direction.
